(19) United States
(12) Patent Application Publication
(10) Pub. No.: US 2025/0302229 A1
(43) Pub. Date: Oct. 2, 2025

(54) Weight Scale and Methods of Operating the Same

(71) Applicant: Acaia Corporation, Alhambra, CA (US)

(72) Inventors: Rex Poway Tseng, Taipei (TW); Chien-Chun Han, Taipei (TW)

(21) Appl. No.: 18/622,248

(22) Filed: Mar. 29, 2024

(51) Int. Cl. A47J 31/44; G01D 21/02; G01G 17/04; G01G 19/40

(52) U.S. Cl. CPC A47J 31/44; G01D 21/02; G01G 17/04; G01G 19/40

(57) ABSTRACT

A scale, or methods for operating the same, may involve a platter, a load sensor, an electronic display, and a controller. The platter may be provided to receive a scale load thereon. The load sensor may be mounted below the platter in mechanical connection therewith to detect a mass of the scale load. The electronic display may be attached to the platter. The controller may be operably connected to the load sensor and the electronic display. The controller may be configured to perform operations for timing or weight stabilization.

### FIELD OF THE DISCLOSURE

The present subject matter relates generally to weighing devices or scales, and more particularly to coffee scales, including methods of operating the same.

### BACKGROUND OF THE DISCLOSURE

Coffee, in its many forms and according to numerous brewing methods, is one of the most popular beverages throughout the world. Typical brewing methods broadly include immersion and percolation. In either case, coffee beans are ground into a powder (i.e., coffee grounds) before being introduced to water in order to extract various chemical compounds and flavors to create a coffee beverage.

Generally, the flavor and texture of a coffee beverage will be influenced or affected by both the mass ratio of coffee grounds to water, as well as the time in which a specific mass of water interacts (e.g., steeps, mixes, or strains through) the coffee grounds. As a result, an accurate coffee scale may be useful to measure coffee beans/grounds and water. In order to maintain consistency or quality of a resulting coffee beverage, many users may use a manual stopwatch or timer device to measure various time characteristics of the brewing process (e.g., flow rate or interaction time between coffee grounds and water).

### BRIEF DESCRIPTION OF THE DISCLOSURE

Aspects and advantages of the disclosure will be set forth in part in the following description, or may be obvious from the description, or may be learned through practice of the disclosure.

In one exemplary aspect of the present disclosure, a scale is provided. The scale may include a platter, a load sensor, an electronic display, and a controller. The platter may be provided to receive a scale load thereon. The load sensor may be mounted below the platter in mechanical connection therewith to detect a mass of the scale load. The electronic display may be attached to the platter. The controller may be operably connected to the load sensor and the electronic display. The controller may be configured to perform operations comprising receiving a plurality of preliminary weight signals from the load sensor, determining a preliminary weight delta between the plurality of preliminary weight signals, determining the preliminary weight delta is within a preliminary threshold, based on the preliminary weight delta being within the preliminary threshold, initiating a pour-detection sequence, and initiating, via a timer device, an auto-timer sequence based on the pour-detection sequence. The pour-detection sequence may include detecting a first weight delta rate on the scale and detecting a second weight delta rate on the scale following detecting the first weight delta rate.

In another exemplary aspect of the present disclosure, a scale is provided. The scale may include a platter, a load sensor, an electronic display, and a controller. The platter may be provided to receive a scale load thereon. The load sensor may be mounted below the platter in mechanical connection therewith to detect a mass of the scale load. The electronic display may be attached to the platter. The controller may be operably connected to the load sensor and the electronic display. The controller may be configured to perform operations comprising receiving a plurality of weight signals from the load sensor, determining a stabilization period for the received plurality of weight signals, comparing the determined stabilization period to a set stability threshold, and setting a moving average band on the scale based on the comparison of the determined stabilization period to the set stability threshold.

In yet another exemplary aspect of the present disclosure, a method of operating a scale is provided. The method may include detecting a preliminary weight delta on the scale within a preliminary threshold and, based on the preliminary weight delta being within the preliminary threshold, initiating a pour-detection sequence. The pour-detection sequence may include detecting a first weight delta rate on the scale, and detecting a second weight delta rate on the scale following detecting the first weight delta rate. The method may further include initiating an auto-timer sequence based on the pour-detection sequence. The method may still further include providing command instructions to present a timer animation on an electronic display of the scale, the timer animation corresponding to the auto-timer sequence.

These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures.

FIG. 1 provides a plan view of a scale according to exemplary embodiments of the present disclosure.

FIG. 2 provides a schematic section view of the exemplary scale of FIG. 1.

FIG. 3 provides a flow chart illustrating a method of operating a scale according to exemplary embodiments of the present disclosure.

FIG. 4 provides a flow chart illustrating a method of operating a scale according to exemplary embodiments of the present disclosure.

FIG. 5 provides a schematic view of a controller according to exemplary embodiments of the present disclosure.

FIG. 6 provides a chart illustrating various steps for operating a scale according to exemplary embodiments of the present disclosure.

FIG. 7 provides a chart illustrating various steps for operating a scale according to exemplary embodiments of the present disclosure.

Repeat use of reference characters in the present specification and drawings is intended to represent the same or analogous features or elements of the present disclosure.

### DETAILED DESCRIPTION

Reference now will be made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope of the disclosure. For instance, features illustrated or described as part of one embodiment can be used with another embodiment to yield a still further embodiment. Thus, it is intended that the present disclosure covers such modifications and variations as come within the scope of the appended claims and their equivalents. The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Aspects of the present disclosure may provide a scale (e.g., coffee scale) capable of detecting a liquid (e.g., water or brewed coffee) being poured onto a container supported by the scale and subsequently activating a timer. Additional or alternative aspects of the present disclosure may provide a scale (e.g., coffee scale) capable of varying the speed at which the scale detects and displays weight or mass thereon. It may be useful to provide an electronic coffee scale or method capable of accurately measuring time following the introduction of a liquid (e.g., automatically or without direct user input to start a timer or timing function), such as from the pouring of water or the flow of an espresso shot. For example, it would be beneficial from a technical and user-experience perspective to not automatically start a timer when preparing a pour (e.g., placing a dripper on the scale, adding coffee ground to the filter on the scale, etc.), and to automatically start the timer when the actual pour starts (e.g., when the user starts pouring water). Additionally or alternatively, it may be useful to provide an electronic coffee scale or method capable of measuring and outputting weight or mass (i.e., outputting weight or mass measurements) in a manner that is relatively responsive and stable, such that the output measurements can be easily understood during a brewing process (e.g., even in an environment that changes over time, such as in a typical home or café).

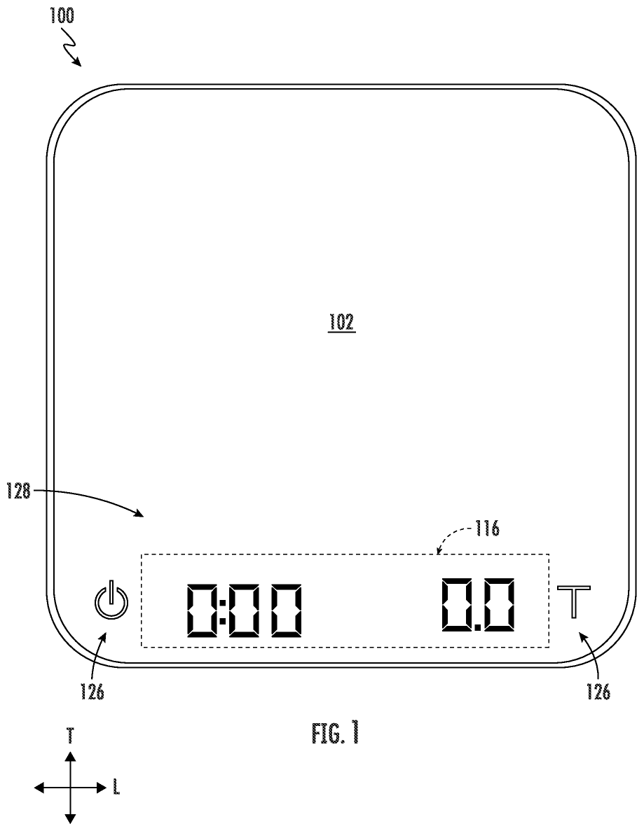

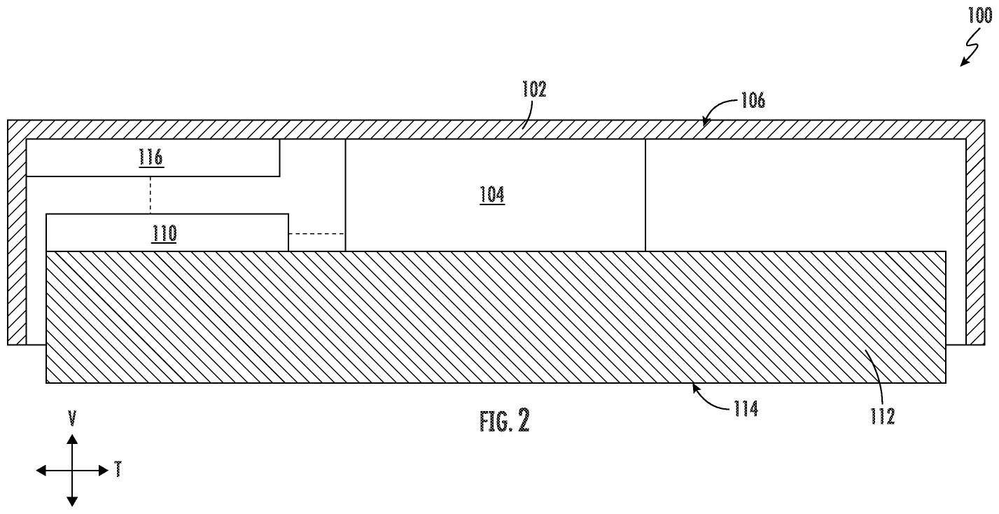

Turning now to the figures, FIGS. 1 and 2 provide views of a scale 100 (e.g., electronic coffee scale) according to exemplary embodiments of the present disclosure. Generally, scale 100 defines a mutually orthogonal vertical direction V, lateral direction L, and transverse direction T. Scale 100 may provide a platter 102 and a load sensor 104 to receive and detect the mass of a scale load (e.g., receptacle, cup, container, vessel, coffee beans, volume of liquid, food item, etc.). For instance, the platter 102 may be formed from one or more suitable materials (e.g., rigid metal or polymer) and define an upper receiving surface 106 onto which the scale load may be placed or supported.

Below the upper receiving surface 106, the load sensor 104 may be mounted. Specifically, the load sensor 104 may be mounted in mechanical connection with the platter 102. During use a force or moment generated by the weight of the scale load is transferred (at least in part) through the platter 102 to the load sensor 104. In turn, the load sensor 104 may be able to detect the mass of the scale load. Generally, load sensor 104 is provided as or includes any suitable electronic load sensor or cell (e.g., one or more electronic load sensors or cells) configured to generate one or more electronic signals according (e.g., in proportion to) a mass of load thereon. For instance, load sensor 104 may include a suitable strain gauge, force sensitive resistor, capacitance sensor, hydraulic pressure sensor, or pneumatic pressure sensor—as would be understood. As will be described in greater detail below, the load sensor 104 may be in operable (e.g., wireless or electrical) communication with a controller 110 to which the generated electronic signals may be communicated.

In some embodiments, a base frame 112 is provided to support the platter 102 or load sensor 104. For instance, the base frame 112 may be disposed below one or both the platter 102 and load sensor 104. The base frame 112 may include or define a bottom base surface 114 that is directed downward to sit on or contact a support surface (e.g., countertop or other structure onto which the scale 100 is placed). The load sensor 104 may be sandwiched or disposed between at least a portion of the platter 102 (e.g., at the upper surface 106) and at least a portion of the base frame 112 (e.g., at the bottom base surface 114), such as relative to the vertical direction V. In some such embodiments, the platter 102 (e.g., at least portion thereof) “floats” or may otherwise be deflectable (e.g., along the vertical direction V) relative to the base frame 112. During use, reception of the scale load may thus act to push, bend, or deform the platter 102, which may in turn be transferred to the load sensor 104 to subsequently detect (or facilitate detection of) the mass of the scale load, as would be understood.

In certain embodiments, an electronic display 116 is provided with scale 100. In particular, the electronic display 116 may be attached (e.g., directly or, alternatively, indirectly) to the platter 102 or base frame 112. For instance, the electronic display 116 may be supported on the base frame 112. Optionally, the electronic display 116 be provided on or beneath at least a portion of the platter 102. In the illustrated embodiments, the electronic display 116 is supported on the platter 102 beneath the upper surface 106. As shown, the electronic display 116 may be directed (e.g., upward) through the platter 102 to project at least a portion of the display to the upper surface 106, such as in a dead front display. Generally, the electronic display 116 include or be provided as any suitable electrically activated display (e.g., in operable communication with the controller 110), such as a digital screen, electronic segment display, projector, liquid crystal display (LCD), vacuum fluorescent display (VFD), light emitting diode (LED), electroluminescent display (ELD), plasma display panel (PDP), cathode-ray tube (CRT), or laser-powered phosphor display (PLD).

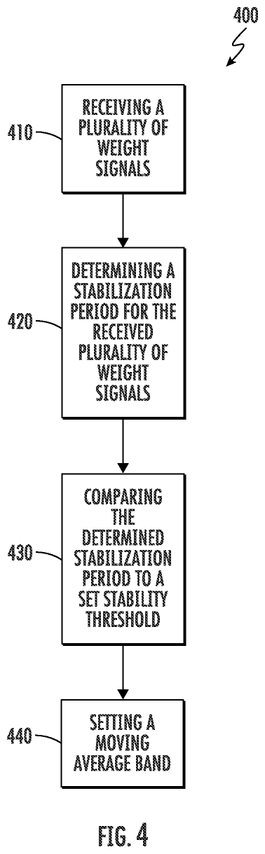

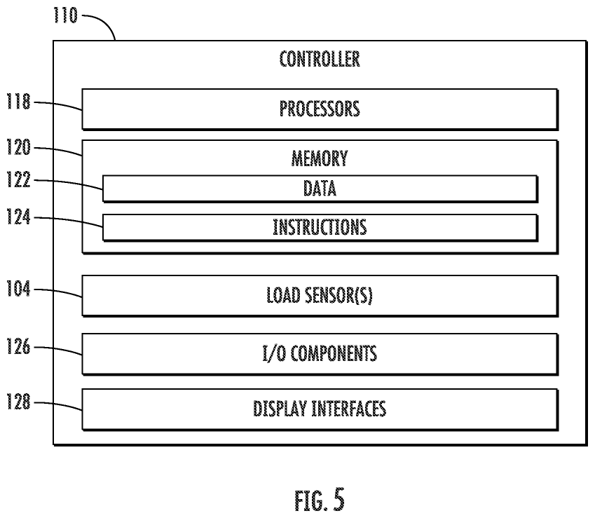

Turning now to FIGS. 4 and 5, the controller 110 may be attached (e.g., directly or, alternatively, indirectly) to the platter 102 or base frame 112. The controller 110 includes one or more processors 118 and a memory 120. The one or more processors 118 can be any suitable processing device (e.g., a processor core, a microprocessor, an ASIC, a FPGA, a microcontroller, etc.) and can be one processor or a plurality of processors that are operatively connected. The memory 120 can include one or more non-transitory computer-readable storage mediums, such as RAM, ROM, EEPROM, EPROM, flash memory devices, magnetic disks, etc., and combinations thereof. The memory 120 can store data 122 and instructions 124 which are executed by the processor 118 to cause the controller 110 to perform operations.

The controller 110 can also include one or more user input component 126 that receives user input. For example, the user input component 126 can be a touch-sensitive component (e.g., a touch-sensitive display screen or a touch pad) that is sensitive to the touch of a user input object (e.g., a finger or a stylus). The touch-sensitive component can optionally serve to implement a virtual keyboard. Other example user input components include a microphone, a tactile or physical button, a traditional keyboard, or other means by which a user can provide user input.

In some implementations, the controller 110 can store or provide one or more user interfaces 128, such as the electronic display 116, which may be associated with one or more applications. The one or more user interfaces 128 can be configured to receive inputs or provide data for presentation or display (e.g., image data, text data, audio data, one or more user interface elements, an augmented-reality experience, a virtual reality experience, or other data for display). The user interfaces 128 may be associated with one or more other computing systems (e.g., a server computing system or third party computing system). The user interfaces 128 can include a viewfinder interface, a search interface, a generative model interface, a social media interface, or a media content gallery interface.

The controller 110 may include or receive data from one or more load sensors 104. The one or more sensors 104 may be housed in a housing component that houses the one or more processors 118, the memory 120, or one or more hardware components, which may store, or cause to perform, one or more software packets.

It is noted that, although not pictured, a suitable power source (e.g., battery, AC voltage port, etc.) could be provided in electrical communication with scale 100 to electrically power the same (e.g., as is generally understood).

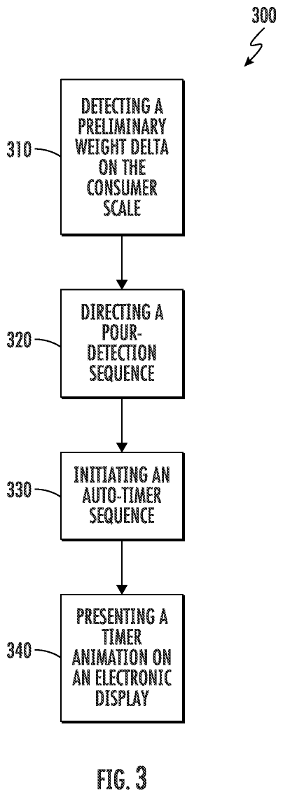

Turning now to FIGS. 3, 4, 6, and 7, the present disclosure may further be directed to methods (e.g., method 300 or 400) of operating a scale, such as scale 100. In exemplary embodiments, the controller 110 may be operable to perform various steps of a method in accordance with the present disclosure.

The methods (e.g., 300 or 400) may occur as, or as part of, a scale operation or general operation of a scale (e.g., scale 100). In particular, the methods (e.g., 300 or 400) disclosed herein may advantageously facilitate automatic detection and timing of a liquid being poured or flowing to the scale (e.g., without direct user input, instruction, or intervention). Additionally or alternatively, the methods (e.g., 300 or 400) disclosed herein may be able to automatically adjust or adapt the detection and/or display of a weight or mass based on changes in the ambient environment (e.g., in a manner that is relatively responsive and stable, such that the output measurements can be easily understood during a brewing process).

It is noted that the order of steps within methods 300 and 400 are for illustrative purposes. Moreover, none of the methods 300 and 400 are mutually exclusive. In other words, methods within the present disclosure may include one or more of methods 300 and 400. All may be adopted or characterized as being fulfilled in a common operation. Except as otherwise indicated, one or more steps in the below method 300 or 400 may be changed, rearranged, performed in a different order, or otherwise modified without deviating from the scope of the present disclosure.

Turning especially to FIG. 3, at 310, the method 300 includes detecting a preliminary weight delta on a scale. Specifically, 310 may include receiving a plurality of preliminary weight signals from the load sensor (e.g., following one or more signal filtration actions, as would be understood). At least two or more of the weight signals may be received sequentially (e.g., at discrete points in time). In other words, two or more of the weight signals may not be simultaneously detected signals. In some embodiments, the plurality of preliminary weight signals are received following a tare action or powering on the scale (e.g., from an unpowered, sleep, or otherwise inactive state). Reception of the preliminary weight signals may, in turn, follow from a determination of a baseline or static weight on the platter.

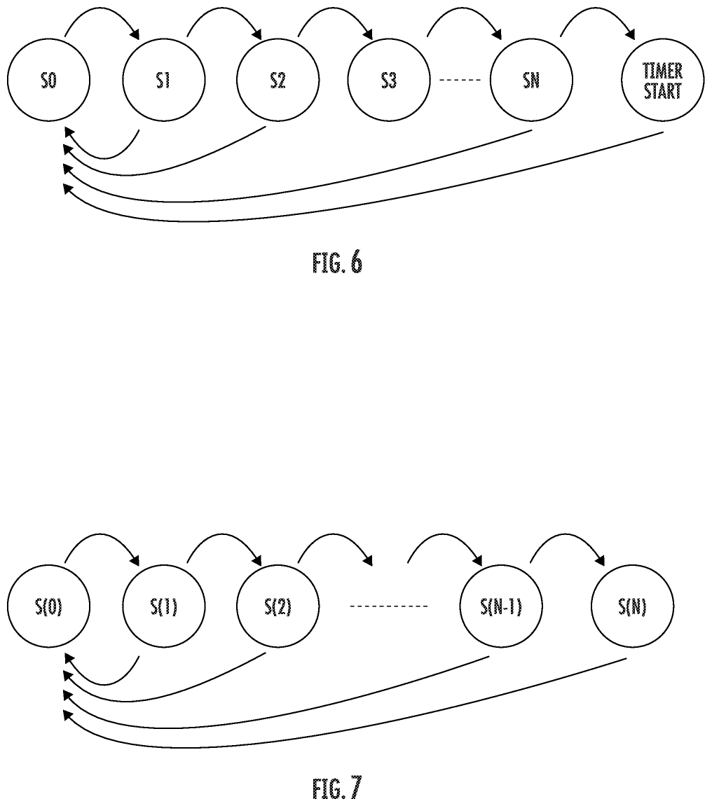

In some embodiments, 310 includes determining the preliminary weight delta between the plurality of preliminary weight signals. Specifically, two or more of the weight signals may be different from each other (e.g., correspond to different masses or loads on the load sensor) and, in turn, correspond to a change in mass (i.e., weight delta) at the platter. Thus, the preliminary weight delta may correspond to a change in mass on the platter to a new or increased weight (e.g., post-static-one weight S1—FIG. 6) from the baseline or static weight (e.g., S0—FIG. 6). The preliminary weight delta may be determined as the difference (e.g., direct or indirect value) in the baseline weight (e.g., as indicated by a baseline or minimum weight signal) and a subsequent or increased weight (e.g., as indicated by a subsequently received weight signal) following the baseline weight. For instance, the baseline or minimum weight signal (or value corresponding to the same) may be subtracted from each subsequently received weight signal to calculate a preliminary weight delta.

In additional or alternative embodiments, 310 includes determining the preliminary weight delta is within a preliminary threshold (e.g., value or range of values for weight). For instance, the determined preliminary weight delta may be compared to a preliminary threshold and, based on that comparison, it may be determined if the preliminary weight delta is within the preliminary threshold. In certain embodiments, the preliminary threshold includes a minimum threshold value (e.g., set or predetermined value programmed within the controller of the scale). Determining that the preliminary weight delta is within the preliminary threshold value may include determining the preliminary weight delta is greater than or equal to the minimum threshold value.

In additional or alternative embodiments, the preliminary threshold includes a maximum threshold value (e.g., set or predetermined value programmed within the controller of the scale). Determining that the preliminary weight delta is within the preliminary threshold value may include determining the preliminary weight delta is less than or equal to the maximum threshold value. For example, when a user places a dripper on the scale 100, the weight delta is larger than the preset maximum threshold value, and the timer would not automatically start (i.e., auto-start).

In some embodiments, the preliminary threshold may include or be provided as a set value corresponding to a selected mode or action (e.g., a pour-over brewing mode, an espresso brewing mode, an immersion brewing mode, etc.), such as might be selected by a user or automatically selected by the controller. In some embodiments, the preliminary threshold may be manually set by the user.

It is noted the method 300 may account for receiving and disregarding one or more preliminary weight signals (e.g., prior to determining the preliminary weight delta is within a preliminary threshold). For instance, one or more preliminary weight signals may be received and used (e.g., with the baseline value) to determine a weight delta from the baseline weight that is compared to the preliminary threshold and determined to be outside of the preliminary threshold (e.g., below or above the preliminary threshold as an insufficient weight delta or excessive weight delta, respectively). In optional embodiments, the method 300 may provide for successively (e.g., continuously or according to a set time interval) receiving preliminary weight signals, determining an insufficient or excessive weight delta, and comparing the insufficient or excessive weight delta to the preliminary threshold prior to completing 310 and proceeding through the method 300. Thus, a weight delta determined to be within the preliminary threshold may be required for proceeding to a subsequent step (e.g., 320).

At 320, the method 300 includes directing a pour-detection sequence for detecting that a liquid is being poured or is flowing to the scale (e.g., following 310). In some embodiments, 320 includes initiating the pour-detection sequence based on the preliminary weight delta of being within the preliminary threshold at 310. Optionally, and as will be described in greater detail below, the pour-detection sequence may generally provide guidance or an expected template for changes in mass corresponding to a liquid being poured or flowing to the scale (e.g., in a coffee or beverage-making process).

Initiating the pour-detection sequence may include detecting a first weight delta on the scale following 310. In other words, a plurality of working weight signals may be received from the load sensor subsequent to 310. As described above, at least two or more of the weight signals may be received sequentially (e.g., at discrete points in time). In other words, two or more of the weight signals may be different weight signals that are not simultaneously detected (e.g., from post-static-one weight S1 to post-static-two weight S2) and, in turn, correspond to a change in mass (i.e., weight delta) at the platter. Thus, the first weight delta may correspond to a change in mass on the platter to a new or increased weight (e.g., S2-FIG. 6) from the previous weight (e.g., S1-FIG. 6). The first weight delta may be determined as the difference (e.g., direct or indirect value) in the previous weight (e.g., as indicated by a prior weight signal) and a subsequent or increased weight (e.g., as indicated by a new subsequently received weight signal) following the previous weight. For instance, the previous weight signal (or value corresponding to the same) may be subtracted from a subsequently received weight signal to calculate a first weight delta (Δw1) (e.g., change in detected weight from S1 to S2).

In some embodiments, the time interval between detection of the previous weight signal (e.g., t(1)) and detection of the subsequent or increased weight signal (e.g., t(2)) is further provided to determine a first weight delta rate. Thus, a timer or timing sequence may be initiated in tandem with reception of the plurality of working signals (e.g., to timestamp each discrete weight signal or otherwise track the change in time between detection of S1 and S2). The time interval may be understood as a first time interval (Δt1).

In some embodiments, 320 includes that the first weight delta rate be within a first rate threshold (1). Thus, 320 may include determining that the first weight delta rate is within a first rate threshold (e.g., value or range of values for weight over time). For instance, the determined first weight delta over the corresponding time interval (e.g., Δw1/Δt1) may be compared to a first rate threshold (η1) and, based on that comparison, it may be determined if the first weight delta rate is within the first rate threshold. In certain embodiments, the first rate threshold includes a minimum first rate value (e.g., η1_min, set or predetermined value programmed within the controller of the scale). For example, the minimum first rate value may correspond to a typical flow rate of a coffee pour or espresso drip. Determining that the first weight delta rate is within the first rate threshold may include determining the first weight delta over the corresponding time is greater than or equal to the minimum threshold value (e.g., (Δw1/Δt1)≥ η1_min). In additional or alternative embodiments, the first rate threshold includes a maximum threshold value (e.g., η1_max, set or predetermined value programmed within the controller of the scale). Determining that the preliminary weight delta rate is within the first rate threshold may include determining the first weight delta rate is less than or equal to the maximum threshold value (e.g., (Δw1/Δt1)≤η1_max). For example, the first rate threshold may include a maximum threshold value between about 100 milligrams over 0.2 seconds and about 200 milligrams over 0.2 seconds.

Multiple determinations of expected weight changes may be required in order to detect a pouring action as part the pour-detection sequence. In some such embodiments, 320 further includes detecting a second weight delta on the scale following detection of the first weight delta. In other words, a plurality of working weight signals may be received from the load sensor subsequent to detection of the first weight delta. As described above, at least two or more of the weight signals may be received sequentially (e.g., at discrete points in time). In other words, two or more of the weight signals may be different weight signals that are not simultaneously detected (e.g., from post-static-two weight S2 to post-static-three weight S3) and, in turn, correspond to a change in mass (i.e., weight delta) at the platter. Thus, the second weight delta may correspond to a change in mass on the platter to a new or increased weight (e.g., S3-FIG. 6) from the previous weight (e.g., S2-FIG. 6). The second weight delta may be determined as the difference (e.g., direct or indirect value) in the previous weight (e.g., as indicated by a prior weight signal) and a subsequent or increased weight (e.g., as indicated by a new subsequently received weight signal) following the previous weight. For instance, the previous weight signal (or value corresponding to the same) may be subtracted from a subsequently received weight signal to calculate a second weight delta (Δw2) (e.g., change in detected weight from S2 to S3).

In some embodiments, the time interval between detection of the previous weight signal (e.g., t(2)) and detection of the subsequent or increased weight signal (e.g., t(3)) is further provided to determine a second weight delta rate. Thus, a timer or timing sequence may be initiated in tandem with reception of the plurality of working signals (e.g., to timestamp each discrete weight signal or otherwise track the change in time between detection of S2 and S3). The time interval may be understood as a second time interval (Δt2).

In some embodiments, 320 includes or requires that the second weight delta rate be within a second rate threshold (η2). Thus, 320 may include determining that the second weight delta rate is within a second rate threshold (e.g., value or range of values for weight over time). For instance, the determined second weight delta over the corresponding time interval (e.g., Δw2/Δt2) may be compared to a second rate threshold (η2) and, based on that comparison, it may be determined if the second weight delta rate is within the second rate threshold. In certain embodiments, the second rate threshold includes a minimum second rate value (e.g., η2_min, set or predetermined value programmed within the controller of the scale). Determining that the second weight delta rate is within the second rate threshold may include determining the second weight delta over the corresponding time is greater than or equal to the minimum threshold value (e.g., (Δw2/Δt2)≥ η2_min). In additional or alternative embodiments, the second rate threshold includes a maximum threshold value (e.g., η2_max, set or predetermined value programmed within the controller of the scale). Determining that the preliminary weight delta rate is within the second rate threshold may include determining the second weight delta rate is less than or equal to the maximum threshold value (e.g., (Δw2/Δt2)≤η2_max). Optionally, the second rate threshold may include a minimum threshold value between about 10 grams over 0.5 seconds.

In some embodiments, each rate threshold may be distinct or different from one or all of the other rate thresholds. For instance, the first rate threshold may be different from (e.g., include one or more threshold values that are greater than or less than) the second rate threshold (e.g., η1 Æη2). In alternative embodiments, one or more rate thresholds may be identical to or equal to each other. For instance, the first rate threshold may be the same (e.g., include one or more threshold values that are equal to) the second rate threshold (e.g., η1=η2). Optionally, one or more of the rate thresholds may include or be provided as a set value (or values) corresponding to a selected mode or action (e.g., a pour-over brewing mode, an espresso brewing mode, an immersion brewing mode, etc.), such as might be selected by a user or automatically selected by the controller. Thus, a rate threshold may be varied according to the particular mode or action that the scale is directed to perform. One value (or values) for a rate threshold (e.g., the first or second rate threshold) may be set for a first (e.g., pour-over) brewing mode while another value (or values) for the same rate threshold may be set for a second (e.g., espresso) brewing mode.

As noted above, multiple determinations of expected weight changes may be required to detect a pouring action as part the pour-detection sequence. Such detections may be required to be consecutive. In some embodiments, a programmed consecutive weight delta counter may be provided (e.g., within the controller). Each determination of a delta rate within a corresponding threshold may prompt advancing of the counter as part of 320. For instance, 320 may include advancing a consecutive weight delta counter in response to determining the first weight delta rate is within the first rate threshold. Additionally or alternatively, 320 may include further advancing the consecutive weight delta counter in response to determining the second weight delta rate is within the second rate threshold. Subsequent consecutive determinations of a weight delta (e.g., S (N)-S(N−1)) and weight delta rate (e.g., (ΔwN/ΔN) being within a corresponding rate threshold (e.g., ηN) may still further advance the counter—as would be understood in light of the present disclosure. In optional embodiments, a set or programmed threshold counter number may be provided. Thus, reaching the programmed threshold counter number may be required (e.g., following ηN_min≤(ΔwN/ΔtN)≤ηN_max) for proceeding to a subsequent step (e.g., 330).

It is noted that the method 300 may account for or adapt to determinations that an unexpected or non-conforming weight change has been detected as part of 320. Optionally, the counter may be paused, revert, or reset in response to determining a weight delta or weight delta rate is outside of a corresponding rate threshold (e.g., as illustrated at FIG. 6 wherein the process may revert to an earlier post-static position in the sequence, such as to S0).

For instance, 320 may include determining the second weight delta is outside of the corresponding second rate threshold. Subsequently, and based on such a determination, 320 may include detecting a third weight delta rate on the scale based on the determination that the second weight delta is outside of the second rate threshold. Similar to the above-described weight delta determinations, a plurality of working weight signals may be received from the load sensor subsequent to determining the second weight delta is outside of the corresponding second rate threshold (e.g., with or, alternatively, without repeating step 310). As described above, at least two or more of the weight signals may be received sequentially (e.g., at discrete points in time). In other words, two or more of the weight signals may be different weight signals that are not simultaneously detected (e.g., from a post-static-one weight S1 to a new post-static-two weight S2) and, in turn, correspond to a change in mass (i.e., weight delta) at the platter. Thus, the third weight delta may correspond to a change in mass on the platter to a new or increased weight (e.g., S2-FIG. 6) from the previous weight (e.g., S1-FIG. 6). The third weight delta may be determined as the difference (e.g., direct or indirect value) in the previous weight (e.g., as indicated by a prior weight signal) and a subsequent or increased weight (e.g., as indicated by a new subsequently received weight signal) following the previous weight. For instance, the previous weight signal (or value corresponding to the same) may be subtracted from a subsequently received weight signal to calculate a third weight delta (Δw3) (e.g., change in detected weight from S1 to new S2).

In some embodiments, the time interval between detection of the previous weight signal (e.g., t(3)) and detection of the subsequent or increased weight signal (e.g., t(4)) is further provided to determine a third weight delta rate. Thus, a timer or timing sequence may be initiated in tandem with reception of the plurality of working signals (e.g., to timestamp each discrete weight signal or otherwise track the change in time between detection of S1 and new S2). The time interval may be understood as a third time interval (Δt3).

In some embodiments, 320 includes or requires that the third weight delta rate be within a third rate threshold (η3) (e.g., equal to or different from η1). Thus, 320 may include determining that the third weight delta rate is within a third rate threshold (e.g., value or range of values for weight over time). For instance, the determined third weight delta over the corresponding time interval (e.g., Δw3/Δt3) may be compared to a third rate threshold (η3) and, based on that comparison, it may be determined if the third weight delta rate is within the third rate threshold. In certain embodiments, the third rate threshold includes a minimum third rate value (e.g., η3_min, set or predetermined value programmed within the controller of the scale). Determining that the third weight delta rate is within the third rate threshold may include determining the third weight delta over the corresponding time is greater than or equal to the minimum threshold value (e.g., (Δw3/Δt3)≥ η3_min). In additional or alternative embodiments, the third rate threshold includes a maximum threshold value (e.g., η3_max, set or predetermined value programmed within the controller of the scale). Determining that the preliminary weight delta rate is within the third rate threshold may include determining the third weight delta rate is less than or equal to the maximum threshold value (e.g., (Δw3/Δt3)≤η3_max).

Following detecting such as third weight delta (e.g., within the third rate threshold), 320 may further include detecting a fourth rate delta. In other words, a plurality of working weight signals may be received from the load sensor subsequent to detection of the third weight delta. As described above, at least two or more of the weight signals may be received sequentially (e.g., at discrete points in time). In other words, two or more of the weight signals may be different weight signals that are not simultaneously detected (e.g., from new post-static-two weight S2 to a new post-static-three weight S3) and, in turn, correspond to a change in mass (i.e., weight delta) at the platter. Thus, the fourth weight delta may correspond to a change in mass on the platter to a new or increased weight (e.g., S3-FIG. 6) from the previous weight (e.g., S2-FIG. 6). The fourth weight delta may be determined as the difference (e.g., direct or indirect value) in the previous weight (e.g., as indicated by a prior weight signal) and a subsequent or increased weight (e.g., as indicated by a new subsequently received weight signal) following the previous weight. For instance, the previous weight signal (or value corresponding to the same) may be subtracted from a subsequently received weight signal to calculate a fourth weight delta (Δw2) (e.g., change in detected weight from S2 to S3).

In some embodiments, the time interval between detection of the previous weight signal (e.g., t(2)) and detection of the subsequent or increased weight signal (e.g., t(3)) is further provided to determine a fourth weight delta rate. Thus, a timer or timing sequence may be initiated in tandem with reception of the plurality of working signals (e.g., to timestamp each discrete weight signal or otherwise track the change in time between detection of S2 and S3). The time interval may be understood as a fourth time interval (Δt2).

In some embodiments, 320 includes or requires that the fourth weight delta rate be within a fourth rate threshold (η4) (e.g., equal to or different from η2. Thus, 320 may include determining that the fourth weight delta rate is within a fourth rate threshold (e.g., value or range of values for weight over time). For instance, the determined fourth weight delta over the corresponding time interval (e.g., Δw4/Δt4) may be compared to a fourth rate threshold (η4) and, based on that comparison, it may be determined if the fourth weight delta rate is within the fourth rate threshold. In certain embodiments, the fourth rate threshold includes a minimum fourth rate value (e.g., η4_min, set or predetermined value programmed within the controller of the scale). Determining that the fourth weight delta rate is within the fourth rate threshold may include determining the fourth weight delta over the corresponding time is greater than or equal to the minimum threshold value (e.g., (Δw4/Δt4)≥14_min). In additional or alternative embodiments, the fourth rate threshold includes a maximum threshold value (e.g., η4_max, set or predetermined value programmed within the controller of the scale). Determining that the preliminary weight delta rate is within the fourth rate threshold may include determining the fourth weight delta rate is less than or equal to the maximum threshold value (e.g., (Δw4/Δt4)≤η4_max).

At 330, the method 300 includes initiating an auto-timer sequence. Specifically, 330 may include initiating, via a timer device (e.g., as part of the controller, as would be understood), an auto-timer sequence based on the pour-detection sequence of 320. For instance, the auto-timer sequence may be initiated to start measuring time (e.g., in seconds or minutes) in response to determining the set number of consecutive weight deltas within one or more corresponding rate thresholds. Upon or in response to the programmed threshold counter number, the auto-timer sequence may be initiated. In some embodiments, the auto-timer sequence is subsequent to determining the second weight delta is within the second rate threshold. In additional or alternative embodiments, the auto-timer sequence is subsequent to determining the fourth weight delta is within the fourth rate threshold.

At 340, the method 300 includes presenting a timer animation on the electronic display that corresponds to the auto-timer sequence. Specifically, the controller may provide command instructions to present a timer animation on the electronic display, the timer animation corresponding to the auto-timer sequence (e.g., immediately, in tandem with, or in direct response to the auto-timer sequence). The timer animation may be provided as a numerical, relative, or graphical representation of time measured. Moreover, the timer animation may be continuously updated (e.g., at a set refresh rate or standard) according to the auto-timer sequence. Thus, the time measured by the auto-timer sequence may be visible on the electronic display.

Subsequently, the timer animation may be halted by a corresponding user input or upon reaching a predetermined time limit, as would be understood.

In some embodiments, presenting a timer animation may include presenting a timer animation on a separate device (e.g., a smartphone). For example, the scale may include a communication module (e.g., a wireless module) that can communicate with the separate device, and upon initiating the auto-timer sequence, the scale may transmit a signal to a software program on the separate device to present the timer on the separate device to the user.

Turning to FIG. 4, which describes a method for dynamically setting a weighing filter for a scale, at 410, the method 400 includes receiving a plurality of weight signals from the load sensor (e.g., preceding or following one or more signal filtration actions, as would be understood). At least two or more of the weight signals may be received sequentially (e.g., at discrete points in time). In other words, two or more of the weight signals may not be simultaneously detected signals. In some embodiments, the plurality of preliminary weight signals are received following or in response to a tare action or powering on the scale (e.g., from an unpowered, sleep, or otherwise inactive state), such as to determine a baseline or static weight on the platter.

At 420, the method 400 includes determining a stabilization period of the received plurality of weight signals. For instance, 420 may include measuring the time interval from the start of 410 until a stable (e.g., consistent) weight reading is achieved. In other words, and as is generally understood, the time interval required until a set number of consecutive weight signals generally match or indicate the same mass (e.g., within a predetermined tolerance) may be measured.

In some embodiments, 420 may include determining multiple stabilization periods (e.g., each corresponding to a different occurrence of a tare action or powering-on action). Subsequently, a modified stabilization period may be calculated based on the multiple determined stabilization periods. Calculating the modified stabilization period may include applying a mean, median-selection, or other suitable algorithm to the multiple values of the determined stabilization periods.

At 430, the method 400 includes comparing the determined stabilization period (e.g., a single determined stabilization period or the modified stabilization period) of 420 to a set stability threshold. The set stability threshold may include a set or predetermined value programmed within the controller of the scale. Optionally, the set stability threshold may include or be provided as a set value corresponding to a selected mode or action (e.g., a pour-over brewing mode, an espresso brewing mode, an immersion brewing mode, etc.), such as might be selected by a user or automatically selected by the controller.

From the comparison, it may be determined if or how the stabilization period from 420 varies relative to the set stability threshold. Thus, it may be determined if the determined stabilization period is less than or, alternatively, greater than or equal to the set stability threshold.

At 440, the method 400 includes setting a moving average band (e.g., based on 430). The moving average band may generally provide a number of weight signals or readings to be used in a moving average function when determining the weight or mass value to be presented on the electronic display (or other suitable interface). Thus, the mass value presented by the scale may be determined or adjusted, at least in part, by applying the moving average function to the weight signals or readings detected at the load sensor. During use, the moving average function may thereby notably facilitate consistent or easily observed mass readings, such as to smooth out or filter the noise generated when detecting a mass detected at the load sensor.

In some embodiments, the number of readings (i.e., lot size) applied to the moving average function is a variable value based on the comparison at 430. For instance, a determined stabilization period greater than or equal to the set stability threshold may prompt an increase (e.g., by a set interval or value) of the lot size. As illustrated in FIG. 7, determination that a stabilization period is greater than or equal to the set stability threshold may result in an increase in lot size S (x) to S (x+1) (e.g., until a set maximum size, S (N) is reached). By contrast, a determined stabilization period less than the set stability threshold may prompt a decrease (e.g., by a set interval or value or, alternatively, back to a default) of the lot size. As illustrated in FIG. 7, determination that at a stabilization period is less than the set stability threshold may result in a decrease in lot size S (x) to S(0) (e.g., or to another prior size, S (x−1), S1 (1), or S (2)).

As described above, in some embodiments, multiple stabilization periods may be determined. In some embodiments, the method 400 may include comparing each of the multiple stabilization periods to the set stability threshold (e.g., 430). The method 400 may include setting a new moving average band (e.g., 440) upon determining that a subset of the multiple stabilization periods exceeds the set stability threshold. For example, the scale may determine five stabilization periods over time, and compare each of the five stabilization periods to the set stability threshold. The scale may only set a new moving average band if more than three (out of five) stabilization periods exceed the set stability threshold. Such approach can be used to avoid changing the moving average band due to a short-term instability in the environment.

As would be understood in light of the present disclosure, the method 400 may be repeated (e.g., according to a programmed schedule or rate, such as weekly, monthly, or after a predetermined number of tare or powering-on actions) such that the sensitivity of the scale is advantageously variable according to changes in the environment that may affect the output of the load sensor (e.g., while remaining relatively responsive and easily read by a user).

This written description uses examples of the disclosure, including the best mode, and also to enable any person skilled in the art to practice the disclosure, including making and using any devices or systems and performing any incorporated methods.

What is claimed is:

1. A scale comprising:
a platter to receive a scale load thereon;
a load sensor mounted below the platter in mechanical connection therewith to detect a mass of the scale load;
an electronic display attached to the platter; and
a controller operably connected to the load sensor and the electronic display, the controller being configured to perform operations comprising:
receiving a plurality of preliminary weight signals from the load sensor,
determining a preliminary weight delta between the plurality of preliminary weight signals,
determining the preliminary weight delta is within a preliminary threshold,
based on the preliminary weight delta being within the preliminary threshold, initiating a pour-detection sequence, the pour-detection sequence comprising:
detecting a first weight delta rate on the scale, and
detecting a second weight delta rate on the scale following detecting the first weight delta rate, and
initiating, via a timer device, an auto-timer sequence based on the pour-detection sequence.

2. The scale of claim 1, wherein the operations further comprise:
providing command instructions to present a timer animation on the electronic display, the timer animation corresponding to the auto-timer sequence.

3. The scale of claim 1, wherein the pour-detection sequence further comprises:
determining the first weight delta rate is within a first rate threshold.

4. The scale of claim 3, wherein the pour-detection sequence further comprises:
advancing a consecutive weight delta counter in response to determining the first weight delta rate is within the first rate threshold.

5. The scale of claim 4, wherein the first weight delta rate and the second weight delta rate are consecutive weight delta rates, wherein the pour-detection sequence further comprises:
determining the second weight delta rate is within a second rate threshold, and
further advancing the consecutive weight delta counter in response to determining the second weight delta rate is within the second rate threshold.

6. The scale of claim 4, wherein the pour-detection sequence further comprises:
determining the second weight delta rate is outside of a second rate threshold.

7. The scale of claim 6, wherein the pour-detection sequence further comprises:
detecting a third weight delta rate on the scale based on the determination that the second weight delta rate is outside of the second rate threshold,
determining the third weight delta rate is within a third rate threshold,
detecting a fourth weight delta rate on the scale following detecting the third weight delta rate, and
determining the fourth weight delta rate is within a fourth rate threshold.

8. The scale of claim 7, wherein initiating the auto-timer sequence is subsequent to determining the fourth weight delta rate is within the fourth rate threshold.

9. The scale of claim 8, wherein the first weight delta rate and the second weight delta rate are consecutive weight delta rates, wherein the pour-detection sequence further comprises:
determining the second weight delta rate is outside of a second rate threshold, and
resetting the consecutive weight delta counter in response to determining the second weight delta rate is outside of the second rate threshold.

10. The scale of claim 1, wherein the pour-detection sequence further comprises determining a set number of consecutive weight deltas within one or more corresponding rate thresholds, and wherein initiating the auto-timer sequence is in response to determining the set number of consecutive weight deltas within one or more corresponding rate thresholds.

11. The scale of claim 10, wherein the operations further comprise:
setting a detection filter for weight readouts at the scale,
wherein setting the detection filter comprises:
receiving a plurality of weight signals from a load sensor of the scale,
determining a stabilization period for the plurality of weight signals,
comparing the determined stabilization period to a set stability threshold, and
setting a moving average band on the scale based on the comparison of the determined stabilization period to the set stability threshold.

12. A scale comprising:
a platter to receive a scale load thereon;
a load sensor mounted below the platter in mechanical connection therewith to detect a mass of the scale load;
an electronic display attached to the platter; and
a controller operably connected to the load sensor and the electronic display, the controller being configured to perform operations comprising:
receiving a plurality of weight signals from the load sensor,
determining a stabilization period for the received plurality of weight signals,
comparing the determined stabilization period to a set stability threshold, and
setting a moving average band on the scale based on the comparison of the determined stabilization period to the set stability threshold.

13. The scale of claim 12, wherein comparing the determined stabilization period to the set stability threshold comprises determining the determined stabilization period is greater than the set stability threshold, and
wherein setting the moving average band comprises increasing the moving average band in response to determining the determined stabilization period is greater than the set stability threshold.

14. The scale of claim 13, wherein increasing the moving average band comprises increasing the moving average band by a set interval.

15. The scale of claim 12, wherein comparing the determined stabilization period to the set stability threshold comprises determining the determined stabilization period is less than or equal to the set stability threshold, and
wherein setting the moving average band comprises decreasing the moving average band in response to determining the determined stabilization period is less than or equal to than the set stability threshold.

16. The scale of claim 15, wherein decreasing the moving average band comprises setting the moving average band to a previous band size for the moving average band.

17. The scale of claim 12, wherein determining the stabilization period further comprises determining a plurality of stabilization periods,
wherein comparing the determined stabilization period to the set stability threshold further comprises comparing each of the plurality of stabilization periods to the set stability threshold,
wherein setting the moving average band on the scale further comprises determining that a subset of the plurality of stabilization periods exceeds the set stability threshold, and
wherein the operations further comprise setting, in response to determining that the subset of the plurality of stabilization periods exceeds the set stability threshold, the moving average band on the scale to a new value.

18. A method of operating a scale, the method comprising:
detecting a preliminary weight delta on the scale within a preliminary threshold;
based on the preliminary weight delta being within the preliminary threshold, initiating a pour-detection sequence, the pour-detection sequence comprising:
detecting a first weight delta rate on the scale, and
detecting a second weight delta rate on the scale following detecting the first weight delta rate;
initiating an auto-timer sequence based on the pour-detection sequence; and
providing command instructions to present a timer animation on an electronic display of the scale, the timer animation corresponding to the auto-timer sequence.

19. The method of claim 18, wherein the pour-detection sequence further comprises:
determining the first weight delta rate is within a first rate threshold.

20. The method of claim 18, wherein the pour-detection sequence further comprises determining a set number of consecutive weight deltas within one or more corresponding rate thresholds, and wherein initiating the auto-timer sequence is in response to determining the set number of consecutive weight deltas within one or more corresponding rate thresholds.
